(19) United States
(12) Patent Application Publication
(10) Pub. No.: US 2014/0344411 A1
(43) Pub. Date: Nov. 20, 2014

(54) METHOD FOR DELIVERING LONG POLLING PUSH MESSAGES IN A MULTI-SERVER ENVIRONMENT

(71) Applicant: PIAZZA Technologies, Inc., Palo Alto, CA (US)

(72) Inventors: Renars GAILIS, Riga (LV); Janis DZERVE, Riga (LV)

(73) Assignee: PIAZZA Technologies, Inc., Palo Alto, CA (US)

(21) Appl. No.: 13/895,250

(22) Filed: May 15, 2013

(51) Int. Cl. H04L 29/08

(52) U.S. Cl. CPC H04L 67/26
USPC 709/219

(57) ABSTRACT

Techniques are disclosed for solving deliverability issues of HTTP long polling push messages in a multi-server environment. When a push server generates a push event to be sent to a client web browser, the push server affixes an identifier and a timestamp to the push event. The client web browser application retains all recent push event identifiers in a list, and the push server retains all recent push events in memory. When the client web browser application requests a subsequent push connection, the browser application sends the list of event identifiers to the push server. Using this list, the push server evaluates which of these identifiers corresponds to the earliest event, and from there generates a list of push events that have occurred after that earliest event. Then, the push server compares this generated list with the browser application's list of identifiers for missing events in the identifier list. The push server delivers all missing events to the client web browser application.

### BACKGROUND

1. Field

Embodiments disclosed herein generally relate to techniques for distributing HTTP long polling push messages in a multi-server environment. The techniques ensure that a client receives each push event generated by a push server given a reasonable amount of reconnection and distribution delays.

2. Description of the Related Art

Many interactive web services use HTTP long polling push methods to deliver content to a client web browser. Generally, a client web browser opens a push connection with a server and requests information, and the server keeps the connection open until a push event is available for the client (or until the connection times out). Once a push event is available (or after a suitable timeout), the server sends the push event or events (if any) to the client and closes the connection. When the client web browser has received the push event, the browser renders the push event message. After a time period following the connection closing, the client web browser opens a new connection with the server. This results in the server almost always having an available waiting request to deliver data in response to a push event. Further, HTTP long polling push methods may be implemented across multiple load-balanced servers in a network. In a multi-server environment, each web server may accept client connections and generate push events. When one server generates (or receives) an event, it distributes that push event to other servers in a load balancing pool, so clients may connect to any push server and receive push events generated across different servers.

However, maintaining consistent distribution of long poll push messages to a client web browser in a multi-server environment presents several challenges. For instance, a server may experience delay between generating a push event and distributing the push event to other push servers in the network. This may result in servers receiving push events from other servers in a different order. Further, because a client waits for a certain period of time between receiving a set of push events from the server and establishing a new push connection, a server may have generated new push events for the client during the wait time. So upon establishing a new push connection, the client may reconnect to another server, and the server needs to determine which events the client has received. A server may check the timestamp of when the push event was received, but push events may be ordered differently due to the asynchronous nature of the push events being generated and distributed among other push servers in the server pool. This can lead to inconsistent delivery. That is, a client may receive events out of order or not receive some push events.

One approach to handle these issues is to implement a server affinity model that assigns a client to a particular server. This approach allows a client to receive push messages in the order generated because the client always connects to the same server. However, this approach is less than ideal in some situations, e.g., where a server goes offline. Further, this approach limits flexibility because clients are shuffled across different servers (e.g., when new servers are added), and the servers need to be able to effectively track affinities, creating issues as a web service obtains more users.

### SUMMARY

Embodiments presented herein include a method for distributing push events shared with a plurality of one or more servers to a client, each push event having an identifier and a timestamp. This method may generally include receiving, over a network connection, a request to establish a push connection with the client. This method may also include receiving, from the client, a first list, wherein the first list includes a set of push event identifiers received by the client over a specified receiving period. An earliest push event from the first list is determined, and a second list that includes a set of push events with timestamps having a value later than the timestamp of the earliest push event is generated. The method may also include identifying one or more push events in the second list missing from the first list, and sending the one or more push events to the client.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an example browser interface where push event messages are presented to a user, according to one embodiment.

FIG. 2 illustrates an example computing environment, according to one embodiment.

FIG. 3 illustrates an example push event generated by a server, according to one embodiment.

FIG. 4 illustrates an example scenario of a client computer with a list of recent push event identifiers and a push server storing recent push events in memory, according to one embodiment.

FIG. 5 illustrates a method diagram for distributing push messages to a client web browser, according to one embodiment.

FIG. 6 illustrates a sequence diagram of an interaction between a client and a server for push message distribution, according to one embodiment.

FIG. 7 illustrates an example computing system configured to generate, receive, and distribute push messages, according to one embodiment.

### DETAILED DESCRIPTION

Embodiments presented herein provide techniques that allow a pool of servers in a multi-server environment to reliably deliver push events to clients. More specifically, identifiers and timestamps are assigned to each push event and used to determine which events a client web browser has not yet received. Doing so ensures a consistent distribution of events to a client despite a reasonable amount of client reconnection and server-to-server distribution delays. Further, this approach provides more server flexibility because it requires no server affinity or complicated load balancing logic.

In one embodiment, when a push server generates a push event, the server assigns an identifier to the event. This identifier is unique across all servers in the load balancing pool. Further, the server generating the push event may also assign a timestamp to the push event representing when the server generated the push event or received the event from another server. Assigning a unique identifier and timestamp to a push event prevents a server or a client from receiving duplicate push events. The push server retains each push event for a certain period of time, e.g., sixty seconds.

Further, in one embodiment, a client maintains a list of push event identifiers for events received over a certain period of time, e.g., a sliding window over the last thirty seconds. The time is less than the period that a server retains a push event. When a client requests a connection to the pool of servers, the load balancer assigns the client to one of the servers. Once the connection to a push server is established, the client web browser sends the list of push event identifiers to the server. The server compares the identifiers in the list to identifiers in the stored push events to determine the earliest push event in memory on that server. Once identified, the server creates a list of all push events generated after the earliest event in memory. The server compares the list with the client's event identifier list to determine which push events the client has not yet received. If the server's list contains any push events that are not contained in the client's list (i.e., push events with identifiers missing from the client's event identifier list), then the server pushes the missing events to the client browser. Otherwise, the server keeps the connection open until a new push event is available (or until timeout). Once the client has received the push message, the client updates its list, and the server closes the connection.

This approach does not require complicated load balancing or push event distribution logic. Instead, assigning identifiers and timestamps to push events allows push events to be distributed consistently. Because the push event identifiers are unique across all servers, the servers will not distribute duplicate events. Additionally, even with wait periods between a client receiving an event and reconnecting to a server, this approach ensures that the client receives all push events generated. That is, a server evaluating the client browser's list of recent identifiers may accurately determine which existing push events that the browser has not yet received and send only those events to a client.

In the following, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet.

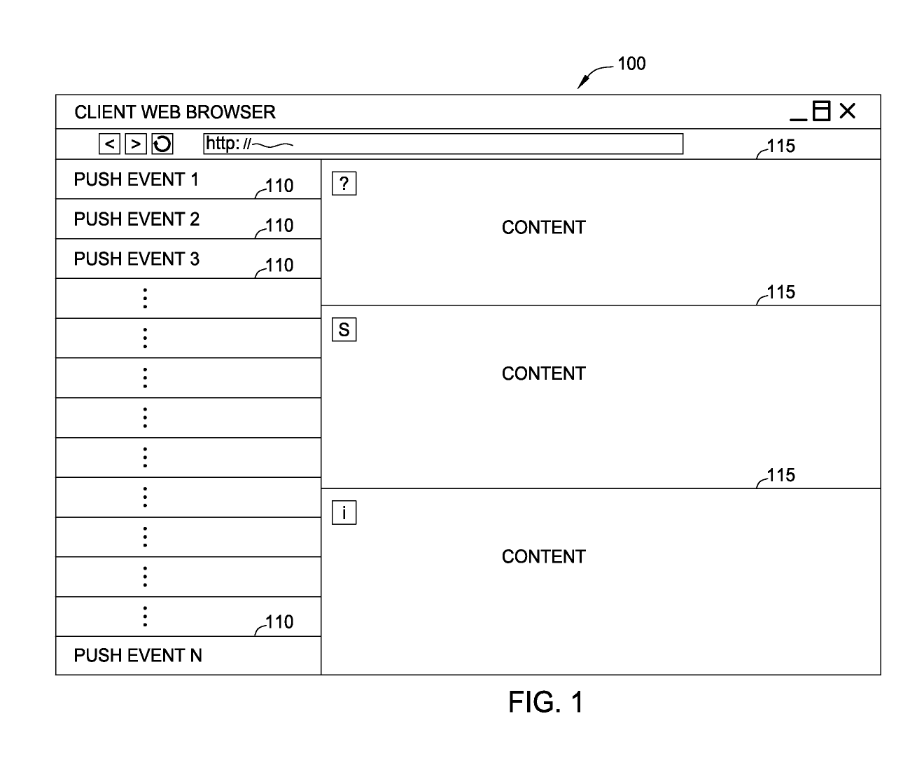

FIG. 1 illustrates an example browser interface 100 where push events are presented to a user, according to one embodiment. As an example, FIG. 1 displays the interface for a collaborative web service that uses push events as a way to present content to a client. The example web service acts as a message forum for university courses and allows users, typically students and instructors of a certain course, to publicly ask questions, answer questions, and post notes directed to the course. To participate in a particular course, a user subscribes to the corresponding course page. The course page serves as an interface that displays push events to a user as user posts (e.g., questions, notes, etc.). The left panel of the interface 100 lists the push events 110. When a course user creates a new post, the server sends a push event 110 to the browser, and the browser dynamically updates the left panel of interface 100. A user may select any post and view its contents 115 on the right panel of interface 100. Using the techniques disclosed, a client may reliably receive all push events, i.e., user posts, generated.

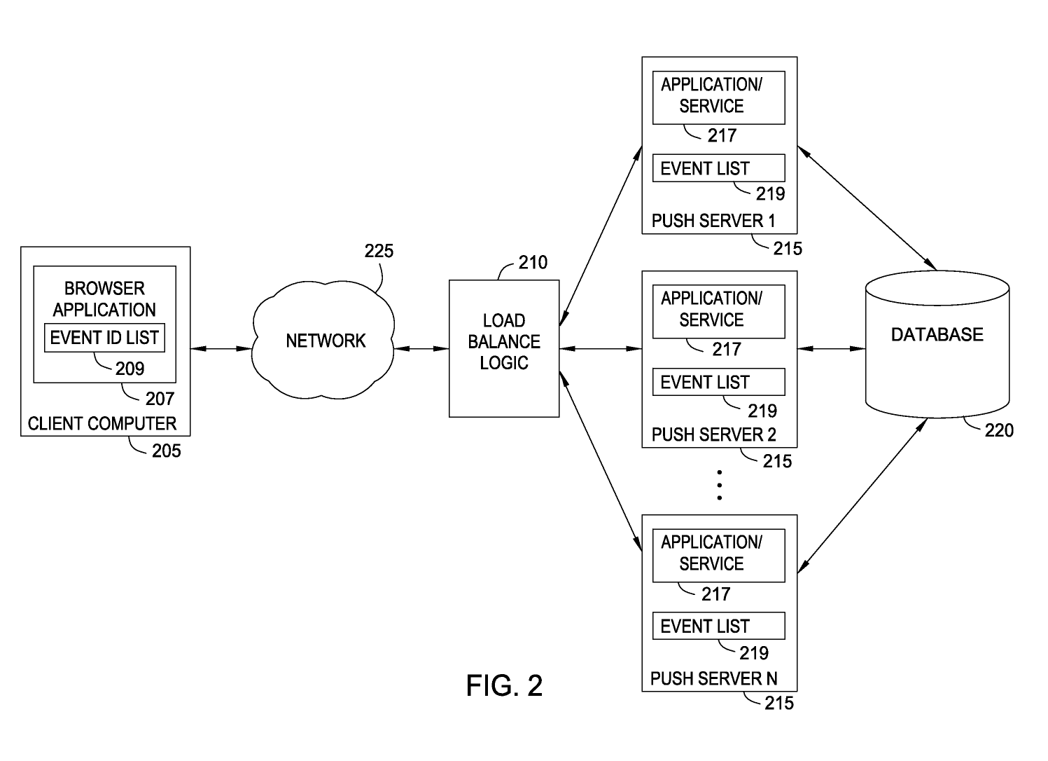

FIG. 2 illustrates an example computing environment 200, according to one embodiment. The computing environment 200 allows a push server 215 to reliably distribute push event messages to a client computer 205 over a network 225. As shown, the computing environment includes a plurality of push servers 215. Each push server 215 in the server pool includes an application/service 217, and an event list 219. Push servers 215 may be physical computing systems (e.g., a system in a data center) or may be virtual computing instances executing within a computing cloud. In any event, push server 215 receives requests from a browser application 207. Upon receiving a request, push server 215 may retrieve HTML and other data from a database 220. Thereafter, a push server 215 generates output for the browser application 207. A load balance logic 210 distributes client requests across all push servers 215 for optimal resource utilization. Application/service 217 is a computing resource that handles the distribution of push events between the client and other servers. For instance, if a user creates a post on the interface through browser application 207, one of the push servers 215 generates a push event in response and distributes the new push event to the other push servers 215 in the server pool. In one embodiment, the event list 219 contains the most recent push events in memory. For example, the push server 215 may store push events that have occurred over the last sixty seconds. The time value for how long a push event remains in memory may be set as a matter of preference.

A client computer 205 includes a browser application 207. When a push server 215 delivers a push event to browser application 207, browser application 207 displays the push event to a user of client computer 205. For instance, using the collaborative web service interface mentioned in FIG. 1 as an example, when a user creates a new post on a course page, the push server may deliver the post to the web browser of another user currently using the interface, and the web browser displays this information to the user. Further, browser application 207 retains the identifier of the push event in an event identifier list 209. Event identifier list 209 retains identifiers of events recently received. For example, event identifier list 209 may retain identifiers of events received in the last thirty seconds. The time value for how long a push event identifier remains in event identifier list 209 may be set as a matter of preference, but the value should be less than the time period that a push server 215 retains a push event in event list 219. This ensures that browser application 207 is able to receive each event retained by push server 215 before push server 215 drops the event. A push server 215 evaluates event identifier list 209 against event list 219 to determine which push events, if any, that browser application 207 has not yet received. Upon identifying such missing events, push server 215 distributes the missing events to browser application 207.

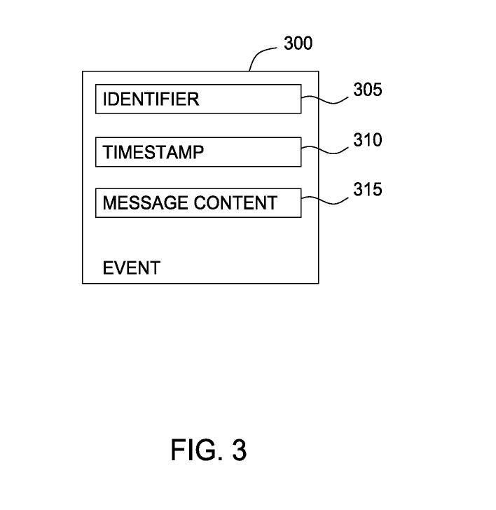

FIG. 3 illustrates an example push event 300 generated by a push server, according to one embodiment. As shown, a push event 300 includes an identifier 305, a timestamp 310, and message content 315. When a push server generates a push event, the server assigns an identifier 305 to the event 300 that is unique across all servers in the network. In one embodiment, a server may create identifier 305 by concatenating a numerical counter increment to the server's own unique identifier. Further, a server assigns a timestamp 310 indicating when the server generated the push event. Alternatively, if the server received the push event 300 from another server, timestamp 310 may indicate when the server received the event. That is, when a server generates a push event 300 and distributes the push event 300 to other servers, the recipient server assigns its own timestamp 310 to the push event 300, i.e., indicating when the event was received. The message content 315 provides the substantive content of the event relative to the web service. Using the education collaborative service interface described above as an example, the message content 315 may correspond to the title of a question, the number of updates made since the question was last seen, the number of “Likes” the question has received, etc.

A push server retains recent push events 300 in memory. In one embodiment, this may correspond to push events 300 generated or received over the last sixty seconds. When a client connects to one of the servers to request push events, the client renders the push event content. Further, the client web browser saves the identifier 305 in a list of recent identifiers. In one embodiment, a client browser retains the identifier for thirty seconds. When a client subsequently opens a push connection to one of the servers in a pool, the client sends the list of recent identifiers to the server. Doing so allows the server to determine which events (if any) the client has not yet received.

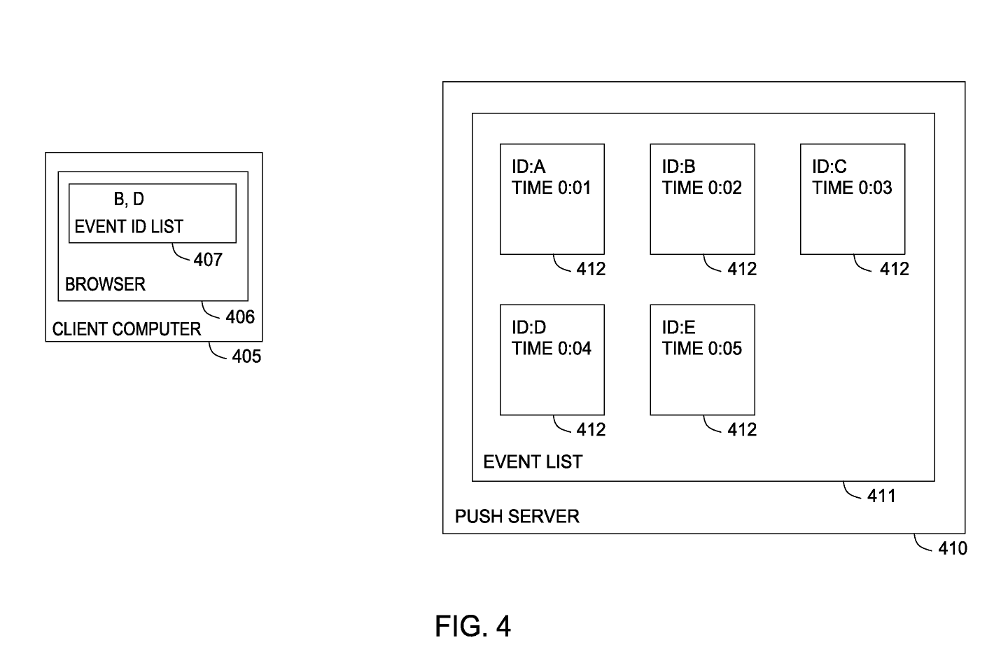

FIG. 4 illustrates an example scenario of a client computer 405 with a list of recent push event identifiers and a push server 410 storing recent push events in memory, according to one embodiment. As shown, the push server 410 maintains an event list 411. The push events in the event list 411 represent events received in the last sixty seconds (or other preset time value). For simplicity, only the identifiers and timestamps of each event 412 are shown in this figure. The events 412 stored in event list 411 have identifiers A, B, C, D, and E, and timestamp values of 0:01, 0:02, 0:03, 0:04, and 0:05 respectively (in m:s format). The client computer 405 includes a browser 406 that maintains a list 407 of event identifiers from events that it has received from the network in the last thirty seconds. The time value may be set as a matter of preference, but it should be less than the amount of time that a server stores a push event in memory.

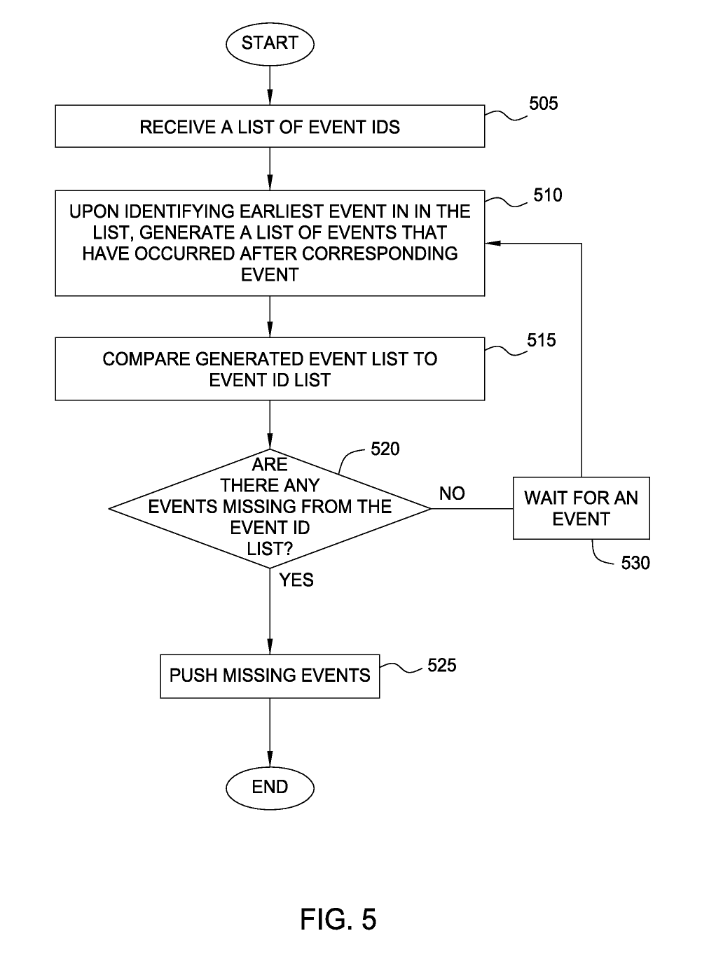

FIG. 5 illustrates a method 500 for distributing push events to a client web browser using the example scenario of FIG. 4, according to one embodiment. More specifically, method 500 illustrates push event distribution from the perspective of a push server. Assume that the client has already sent a request to establish a push connection, and the load balancer has assigned the request to one of the push servers in the server pool. As shown, the method begins at step 505, where the push server 410 receives a request for an update of push events. Note, the request from the client includes a list of event identifiers. Specifically, the list includes any push events received by the client over the last thirty seconds preceding the request. For example, assume client 405 sends an HTTP request for push events, and that such a request is assigned to push server 410 in a load balancing pool. Push server 410 receives the event identifier list 407, which, in this example, contains identifiers B and D. Push server 410 determines which of B and D is the earliest event that client web browser 406 has received by comparing B and D to their corresponding events (using the identifier and timestamp values stored on server 410. In this example, the earliest event 412 in push server 410′s memory is the event 412 with identifier B.

At step 510, the push server generates a list of events that have occurred after the earliest identified event. In the continuing example, the list includes events with identifiers C, D, and E because their timestamps reflect that each event occurred after the event with identifier B. At step 515, the push server compares the generated list to the client web browser's event identifier list. By doing so, the server determines whether any of the events in the generated list are missing from the client web browser's list (step 520). At step 525, the push server sends any missing events to the client and closes the connection. If no events are missing from the list, then the push server waits until a new push event is generated by that server or received from another server (step 530). Alternatively, push server 410 may close the connection after the timeout has elapsed without any events being generated or received. In the example scenario, because the events with corresponding identifiers C and E are missing from the client web browser 406's event list, the push server 410 pushes those events to the client web browser 406. The client web browser application then displays the push events to the user interface.

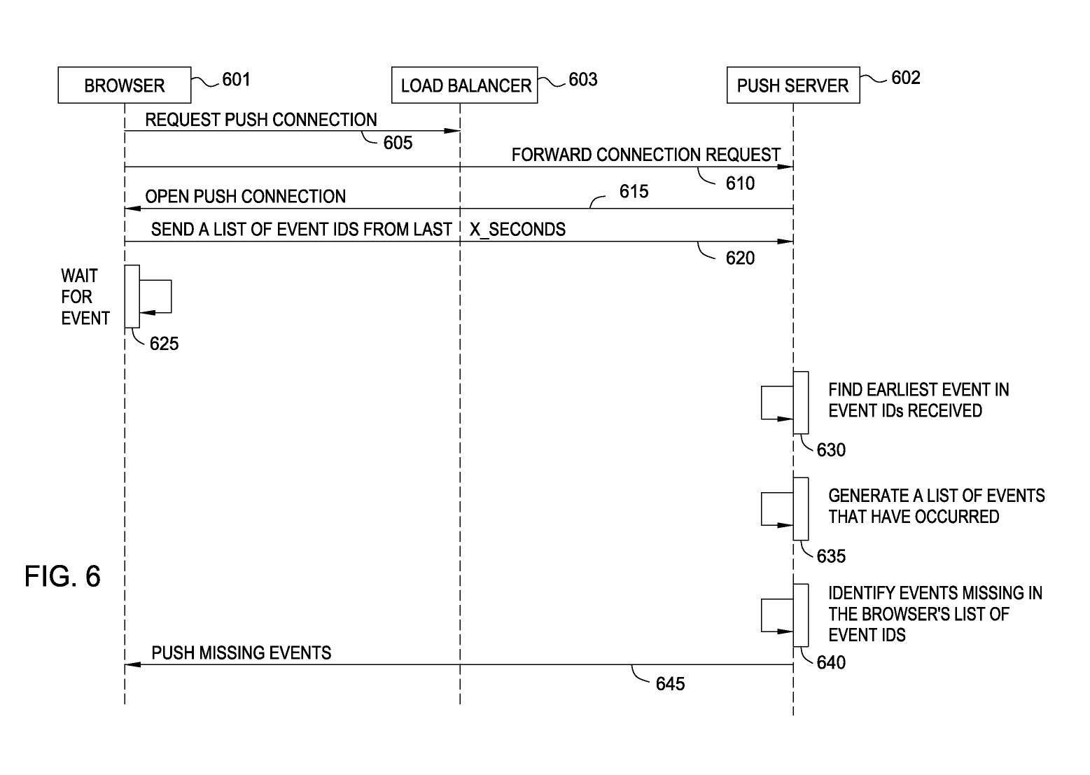

FIG. 6 illustrates a sequence diagram of an interaction between a client browser 601 and a push server 602 during the method described above. As shown, at 605, browser 601 sends a request to a load balancer 603 to initiate a push connection with a push server 602 in the server pool. At 610, load balancer 603 assigns and forwards the request to server 602. Push server 602 sends a response to browser 601 and opens a push connection (at 615). At 620, once the connection is open, the browser 601 sends a list of identifiers of events received within the last preset amount of seconds. While browser 601 waits for an event (at 625), push server 602 evaluates the event identifier list for the identifier that corresponds to the earliest event that push server 602 has in memory (at 630). AOnce push server 602 has identified the earliest event, push server 602 generates a list of events that have occurred since the earliest event was created (at 635). Push server 602 compares the generated list with the event identifier list received from the client to identify events that have not been sent to the client browser (at 640). At 645, push server 602 sends the missing events to browser 601.

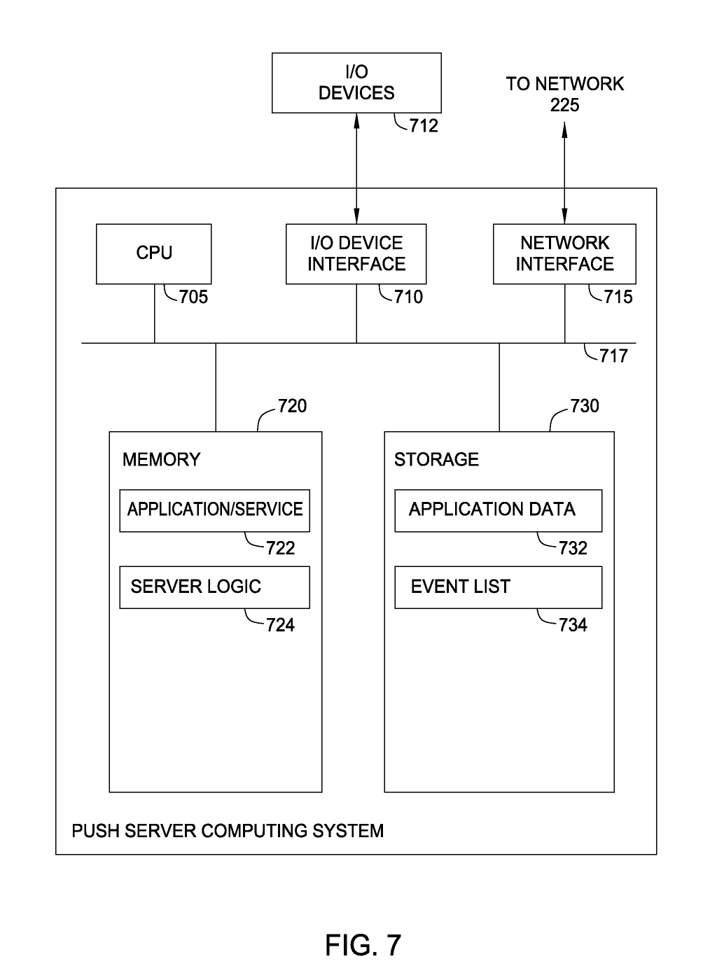

FIG. 7 illustrates an example computing system 700 configured to generate, receive, and distribute push messages using the disclosed techniques, according to one embodiment. As shown, the computing system 700 includes, without limitation, a central processing unit (CPU) 705, a network interface 715, a memory 720, and storage 730, each connected to a bus 717. The computing system 700 may also include an I/O device interface 710 connecting I/O devices 712 (e.g., keyboard, display and mouse devices) to the computing system 700. Further, in context of this disclosure, the computing elements shown in computing system 700 may correspond to a physical computing system (e.g., a system in a data center) or may be a virtual computing instance executing within a computing cloud.

The CPU 705 retrieves and executes programming instructions stored in the memory 720 as well as stores and retrieves application data 732 residing in the storage 730. The interconnect 717 is used to transmit programming instructions and application data between the CPU 705, I/O devices interface 710, storage 730, network interface 715, and memory 720. Note, CPU 705 is included to be representative of a single CPU, multiple CPUs, a single CPU having multiple processing cores, and the like. And the memory 720 is generally included to be representative of a random access memory. The storage 730 may be a disk drive storage device. Although shown as a single unit, the storage 730 may be a combination of fixed and/or removable storage devices, such as fixed disc drives, removable memory cards, or optical storage, network attached storage (NAS), or a storage area-network (SAN).

Illustratively, the memory 720 includes an application/service 722 and a server logic 724. The application/service 732 generally provides one or more software applications and/or computing resources accessed over a network 225 by users. Server logic 724 may be configured to receive requests from a client web browser to open a push connection and send push events. Further, server logic 724 may be configured to generate and distribute push events to other load balanced servers in the network. The storage 730 includes application data 732 and event list 734. When the push server computing system 700 generates or receives a push event, the system 700 stores the push event in the event list 734. Event list 734 contains push events from the last preset amount of time. This amount may be set as a matter of preference, but it should be greater than the value of how long a client web browser keeps received event identifiers in memory.

As described, embodiments presented herein provide techniques for solving deliverability issues in an HTTP long polling push messages in a multi-server environment. Assigning identifiers and timestamps to push events allows a push server in the network to determine which events a client web browser application has not yet received. Further, assigning identifiers to a push event that are across all servers prevents client browsers from receiving duplicate events. Advantageously, this approach does not require server affinities to manage the distribution of push events, allowing for greater flexibility in implementing these methods as a web service acquires more users. Accordingly, embodiments allow servers to consistently deliver push events even if there are delays in server-to-server event distribution or client reconnections.

While the foregoing is directed to embodiments of the present invention, other and further embodiments of the invention may be devised without departing from the basic scope thereof, and the scope thereof is determined by the claims that follow.

What is claimed is:

1. A method for distributing push events shared with a plurality of one or more servers to a client, each push event having an identifier and a timestamp, the method comprising:
receiving, over a network connection, a request to establish a push connection with the client;
receiving, from the client, a first list, wherein the first list includes a set of push event identifiers received by the client over a specified receiving period;
determining an earliest push event from the first list;
generating a second list, wherein the second list includes a set of push events with timestamps having a value later than the timestamp of the earliest push event;
identifying one or more push events in the second list missing from the first list; and
sending the one or more push events to the client.

2. The method of claim 1, wherein determining the earliest push event comprises:
matching the identifiers in the first list to one or more push events located in a storage memory, wherein the push events are stored in the memory over a specified retaining period; and
identifying the push event having an earliest timestamp.

3. The method of claim 1, wherein generating the second list comprises:
parsing push events located in a storage memory, wherein the push events are stored in the memory over a retaining period; and
populating a list of push events having timestamps assigned later than the timestamp of the earliest push event in the first list.

4. The method of claim 1, wherein the request is assigned to one of the plurality of servers.

5. The method of claim 1, wherein the identifier of each push event is created by concatenating a numerical increment value to a server identifier.

6. The method of claim 1, wherein one of the plurality of servers generates a new push event in response to a client action and distributes the new push event to the other servers.

7. The method of claim 6, wherein the other servers assign a corresponding timestamp to the new push event when received.

8. A computer-readable storage medium storing instructions, which, when executed on a processor, performs an operation for distributing push events shared with a plurality of one or more servers to a client, each push event having an identifier and a timestamp, the operation comprising:
receiving, over a network connection, a request to establish a push connection with the client;
receiving, from the client, a first list, wherein the first list includes a set of push event identifiers received by the client over a specified receiving period;
determining an earliest push event from the first list;
generating a second list, wherein the second list includes a set of push events with timestamps having a value later than the timestamp of the earliest push event;
identifying one or more push events in the second list missing from the first list; and
sending the one or more push events to the client.

9. The computer-readable storage medium of claim 8, wherein determining the earliest push event comprises:
matching the identifiers in the first list to one or more push events located in a storage memory, wherein the push events are stored in the memory over a specified retaining period; and
identifying the push event having an earliest timestamp.

10. The computer-readable storage medium of claim 8, wherein generating the second list comprises:
parsing push events located in a storage memory, wherein the push events are stored in the memory over a retaining period; and
populating a list of push events having timestamps assigned later than the timestamp of the earliest push event in the first list.

11. The computer-readable storage medium of claim 8, wherein the request is assigned to one of the plurality of servers.

12. The computer-readable storage medium of claim 8, wherein the identifier of each push event is created by concatenating a numerical increment value to a server identifier.

13. The computer-readable storage medium of claim 8, wherein one of the plurality of servers generates a new push event in response to a client action and distributes the new push event to the other servers.

14. The computer-readable storage medium of claim 13, wherein the other servers assign a corresponding timestamp to the new push event when received.

15. A system, comprising:
a processor and
a memory hosting an application, which, when executed on the processor, performs an operation for distributing push events shared with a plurality of one or more servers to a client, each push event having an identifier and a timestamp, the operation comprising:
receiving, over a network connection, a request to establish a push connection with the client;
receiving, from the client, a first list, wherein the first list includes a set of push event identifiers received by the client over a specified receiving period;
determining an earliest push event from the first list;
generating a second list, wherein the second list includes a set of push events with timestamps having a value later than the timestamp of the earliest push event;
identifying one or more push events in the second list missing from the first list; and
sending the one or more push events to the client.

16. The system of claim 15, wherein determining the earliest push event comprises:
matching the identifiers in the first list to one or more push events located in a storage memory, wherein the push events are stored in the memory over a specified retaining period; and
identifying the push event having an earliest timestamp.

17. The system of claim 15, wherein generating the second list comprises:
parsing push events located in a storage memory, wherein the push events are stored in the memory over a retaining period; and
populating a list of push events having timestamps assigned later than the timestamp of the earliest push event in the first list.

18. The system of claim 15, wherein the request is assigned to one of the plurality of servers.

19. The system of claim 15, wherein the identifier of each push event is created by concatenating a numerical increment value to a server identifier.

20. The system of claim 15, wherein one of the plurality of servers generates a new push event in response to a client action and distributes the new push event to the other servers.

21. The system of claim 20, wherein the other servers assign a corresponding timestamp to the new push event when received.
